(19) United States
(12) Patent Application Publication
(10) Pub. No.: US 2020/0062649 A1
(43) Pub. Date: Feb. 27, 2020

(54) Method for Controlling Clay Impurities in Construction Aggregates and Cementitious Compositions

(71) Applicant: GCP Applied Technologies Inc., Cambridge, MA (US)

(72) Inventors: Lukasz DEBNY, Epping (AU); Lawrence L. Kuo, Acton, MA (US); Shuqiang Zhang, Singapore (SG); Arthur Kyriazis, Melbourne (AU)

(21) Appl. No.: 16/493,091

(22) PCT Filed: Mar. 9, 2018
(86) PCT No.: PCT/US2018/021732

§ 371 Date: Sep. 11, 2019

Related U.S. Application Data
(60) Provisional application No. 62/470,592, filed on Mar. 13, 2017.

(51) Int. Cl. C04B 24/28; C04B 24/26; C04B 14/06; C04B 28/08; C04B 40/00

(52) U.S. Cl. CPC C04B 24/281; C04B 24/2641; C04B 2103/0087; C04B 28/08; C04B 40/0039; C04B 14/06

(57) ABSTRACT

The present invention provides a method for treating clay-bearing aggregates, particularly those used for construction purposes, which involve introducing to clay-bearing aggregates an ion-exchanged polycondensate of dialkylamine and epichlorohydrin having anionic groups comprising both acetate and chloride ionic groups, wherein the acetate is present in an amount of 51-99 percent, and more preferably in the amount of 60-95 percent, based on molar concentration of the anionic groups, whereby chloride ionic groups are minimally present.

### FIELD OF THE INVENTION

This invention relates to the treatment of sand aggregates used for making construction materials, and more particularly to the mitigation of clay in construction aggregates using a low-chloride cationic polymer as will be further described in detail.

### BACKGROUND OF THE INVENTION

Clay materials are often present in construction materials such as concrete, mortar, asphalt, road base, and gas and oil well drilling mud (used for cementing the annulus gap between pipe and well bore) due to their presence in sand, crushed rock or gravel, and other aggregate materials which are typically used in construction applications. Having a lamellar structure, clay can absorb water and chemical agents, resulting in decreased performance of the construction materials. A common method to mitigate the deleterious effect of clays is to wash them from the aggregates. However, beneficial fines can also be removed during washing.

It is known to use quaternary amine compounds for modifying properties or characteristics of clays. For example, in U.S. Pat. Nos. 6,352,952 and 6,670,415 (owned by W. R. Grace & Co.-Conn.), Jardine et al. disclosed that quaternary amines could be used to minimize the adverse effect of clays on dosage efficiency of superplasticizers used in concretes manufactured using sand aggregates that contained such clays.

As another example, in U.S. Pat. Nos. 8,257,490 and 8,834,626, assigned to Lafarge S. A., Jacquet et al. disclosed compositions for “inerting” clays in aggregates which included quaternary amine functional groups, such as diallyldialkyl ammonium, quaternized (meth)acrylates of dialkylaminoalkyl and (meth)acrylamides N-substituted by a quaternized dialkylaminoalkyl. Included among these groups were cationic polymers obtained by polycondensation of dimethylamine and epichlorohydrin. Similar compositions were disclosed by Brocas in World Intellectual Property Organization Application (Publ. No. 2010/112784 A1), also assigned to Lafarge S. A.

It is an objective of the present invention to mitigate the detrimental effects of clays while leaving beneficial fines. Another objective of the present invention is to mitigate the deleterious effects of clays while improving properties of the construction materials. Advantages of this invention include the improvement of mortar and concrete properties (e.g., workability, strength), asphalt properties (e.g., binder demand), and road base properties (e.g., improved flowability). As a result, washing can be reduced or eliminated, and this allows for a greater content of beneficial fines (i.e., small aggregates) to remain in the construction material.

Additional benefits can also be realized for clay stabilization in gas and oil well applications (involving fractured rock formations) to reduce water loss.

### SUMMARY OF THE INVENTION

The present invention relates to clay-mitigation methods and compositions which are believed to be useful in modifying clays that are carried or otherwise mixed within inorganic particulates such as sand aggregates, crushed stone (gravel, rocks, etc.), granulated slag, and other inorganic particulate materials useful in construction materials.

The clay-mitigation agents of the present invention may be incorporated into clay-bearing construction aggregates and materials, such as mortar, concrete, asphalt, road base, or well bore drilling fluids and muds. The clay mitigation agents may be introduced into dry or wet aggregates.

In the case of hydratable cementitious compositions, the clay-mitigation methods and compositions of the present invention can provide improved workability without increasing water demand; and, in the case of treating or washing aggregate materials, the inventive compositions can reduce the effort required for washing and/or disposing of clay contained in the aggregates.

Methods and compositions of the present invention involve the use of a low-chloride cationic polymer which may be described as follows below.

An exemplary method of the present invention for mitigating clay comprises: combining, with a plurality of clay-bearing aggregates, an ion-exchanged polycondensate of dialkylamine and epichlorohydrin as represented by structural formula [I],

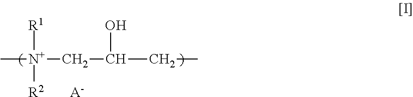

wherein R¹ and R² each independently represent C1 to C3 alkyl groups; and A⁻ represents anionic groups comprising both acetate and chloride ionic groups wherein the amount of acetate is 51-99 percent (and more preferably 60-95 percent, and most preferably 70-90 percent) based on the molar concentration of the anionic groups represented by A⁻; and further wherein A⁻ comprises a chloride ionic group in the amount of 1-49 percent (more preferably 5-40 percent, and most preferably 10-30 percent) based on molar concentration of the anionic groups represented by A⁻.

The present invention also provides admixture compositions containing the above-described low-chloride cationic polymer for treating clay-bearing aggregates in combination with at least one chemical admixture conventionally used for modifying hydratable mortar or concrete, such as one or more water reducing admixtures (e.g., a polycarboxylate comb polymer superplasticizer), or other conventional admixture or admixtures, as will be further described in detail hereinafter.

Exemplary admixture compositions of the invention may be introduced to clay-bearing aggregates at or after the quarry or processing at an aggregates mine, or at the concrete mix plant, where the aggregates are combined with cement to provide mortar or concrete compositions. They may also be introduced into crushed stone or rock which is contaminated with clay, such as crushed gravel or rocks from quarries which are prepared for road base or other construction use (e.g., foundations), and other construction applications.

The above-described low-chloride cationic polymer can also be used, in other construction methods, such as in wellbore drilling applications, such as servicing wellbores using a wellbore servicing fluid, e.g., wellbore drilling (mud) fluid, mud displacement fluid, and/or wellbore cementing composition, to inhibit the swelling of argillaceous (shale or clay) containing subterranean formation penetrated by the wellbore, as hereinafter described in further detail.

Further advantages and benefits of the invention are described in further detail hereinafter.

### DETAILED DESCRIPTION OF PREFERRED EMBODIMENTS

The present invention relates to methods and compositions for treating clays contained in aggregates such as sand, crushed rock, crushed gravel, drilling mud, and other clay-bearing aggregates, which are used in or as part of construction materials. Exemplary compositions of the invention include aggregate compositions, road base, and asphalts, as well as cementitious compositions containing aggregates, such as mortars and concretes.

The present invention relates to treatment of all types of clays. The clays may include but are not limited to swelling clays of the 2:1 type (such as smectite type clays) or also of type 1:1 (such as kaolinite) or of the 2:1:1 type (such as chlorite). The term “clays” has referred to aluminum and/or magnesium silicates, including phyllosilicates having a lamellar structure; but the term “clay” as used herein may also refer to clays not having such structures, such as amorphous clays. The present invention is also not limited to clays which absorb polyoxyalkylene superplasticizers (such as ones containing ethylene oxide (“EO”) and/or propylene oxide (“PO”) groups), but it also includes clays that directly affect the properties of construction materials, whether in their wet or hardened state. Clays which are commonly found in sands include, for example, montmorillonite, illite, kaolinite, muscovite, and chlorite. These are also included in the methods and compositions of the present invention.

Clay-bearing sands and/or crushed rock or gravel which are treated by the method of the present invention may be used in cementitious materials, whether hydratable or not, and such cementitious materials include mortar, concrete, and asphalt, which may be used in structural building and construction applications, roadways, foundations, civil engineering applications, as well as in precast and prefabrication applications.

The term “sand” as used herein shall mean and refer to aggregate particles usually used for construction materials such as concrete, mortar, and asphalt, and this typically involves granular particles of average size between 0 and 8 mm (e.g., not including zero), and, more preferably, between 2 and 6 mm. Sand aggregates may comprise calciferous, siliceous or siliceous limestone minerals. Such sands may be natural sand (e.g., derived from glacial, alluvial, or marine deposits which are typically weathered such that the particles have smooth surfaces) or may be of the “manufactured” type, which are made using mechanical crushers or grinding devices.

The term “cement” as used herein includes hydratable cement and Portland cement which is produced by pulverizing clinker consisting of hydraulic calcium silicates and one or more forms of calcium sulfate (e.g., gypsum) as an interground additive. Typically, Portland cement is combined with one or more supplemental cementitious materials, such as Portland cement, fly ash, granulated blast furnace slag, limestone, natural pozzolans, or mixtures thereof, and provided as a blend. The term “cementitious” refers to materials that comprise Portland cement or which otherwise function as a binder to hold together fine aggregates (e.g., sand), coarse aggregates (e.g., crushed stone, rock, gravel), or mixtures thereof.

The term “hydratable” is intended to refer to cement or cementitious materials that are hardened by chemical interaction with water. Portland cement clinker is a partially fused mass primarily composed of hydratable calcium silicates. The calcium silicates are essentially a mixture of tricalcium silicate (3CaO.SiO₂ “C₃S” in cement chemists notation) and dicalcium silicate (2CaO.SiO₂, “C₂S”) in which the former is the dominant form, with lesser amounts of tricalcium aluminate (3CaO.Al₂O₃, “C₃A”) and tetracalcium aluminoferrite (4CaO.Al₂O₃.Fe₂O₃, “C₄AF”). See e.g., Dodson, Vance H., Concrete Admixtures (Van Nostrand Reinhold, New York N.Y. 1990), page 1.

The term “concrete” will be used herein generally to refer to a hydratable cementitious mixture comprising water, cement, sand, usually a coarse aggregate such as crushed stone, rock, or gravel, and optional chemical admixture(s).

It is contemplated that one or more conventional chemical admixtures may be used in the methods and compositions of the present invention. These include, without limitation, water reducing agents (such as lignin sulfonate, naphthalene sulfonate formaldehyde condensate (NSFC), melamine sulfonate formaldehyde condensate (MSFC), polycarboxylate comb polymers (containing alkylene oxide groups such as “EO” and/or “PO” groups), gluconate, and the like); set retarders; set accelerators; defoamers; air entraining agents; surface active agents; and mixtures thereof.

Of the admixtures, the EO-PO type polymers, which have ethylene oxide (“EO”) and/or propylene oxide (“PO”) groups and polycarboxylate groups, are preferred. Cement dispersants contemplated for use in methods and compositions of the invention include EO-PO polymers and EO-PO comb polymers, as described for example in U.S. Pat. Nos. 6,352,952 B1 and 6,670,415 B2 of Jardine et al., which mentioned the polymers taught in U.S. Pat. No. 5,393,343 (owned by the common assignee hereof). These polymers are available from GCP Applied Technologies Inc., Massachusetts, USA, under the trade name ADVA®. Another exemplary cement dispersant polymer, also containing EO/PO groups, is obtained by polymerization of maleic anhydride and an ethylenically-polymerizable polyalkylene, as taught in U.S. Pat. No. 4,471,100. In addition, EO/PO-group-containing cement dispersant polymers are taught in U.S. Pat. Nos. 5,661,206 and 6,569,234. The amount of such polycarboxylate cement dispersants used within concrete may be in accordance with conventional use (e.g., 0.05% to 0.25% based on weight of active polymer to weight of cementitious material).

Thus, exemplary admixture compositions of the invention comprise at least one chemical admixture, such as one or more polycarboxylate cement dispersants, which is/are preferably polycarboxylate comb polymer(s) having EO and/or PO groups, in combination with the low-chloride cationic polymer, as described herein.

In a first example embodiment, the invention is a method for controlling clay impurities in construction aggregates, comprising: combining, with a plurality of clay-bearing aggregates, an ion-exchanged polycondensate of dialkylamine and epichlorohydrin as represented by structural formula [I],

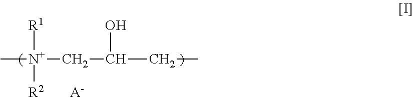

wherein R¹ and R² each independently represent C1 to C3 alkyl groups; and A⁻ represents anionic groups comprising both acetate and chloride ionic groups wherein the amount of acetate is 51-99 percent based on molar concentration of the anionic groups represented by A⁻; and further wherein A⁻ comprises a chloride ionic group in the amount of 1-49 percent based on molar concentration of the anionic groups represented by A⁻.

In a second example embodiment, the invention is a method based on the first example above wherein the amount of acetate is 60-95 percent based on molar concentration of the anionic groups represented by A⁻; and, further, wherein A⁻ comprises a chloride ionic group in the amount of 5-40 percent based on molar concentration of the anionic groups represented by A⁻.

In a third example embodiment, the invention is a method based on the first example above wherein the amount of acetate is 70-90 percent based on molar concentration of the anionic groups represented by A⁻; and, further, wherein A⁻ comprises a chloride ionic group in the amount of 10-30 percent based on molar concentration of the anionic groups represented by A⁻.

In a fourth example embodiment, the invention is a method based on any of the first through third examples above wherein both R¹ and R² each independently represent methyl groups.

In a fifth example embodiment, the invention is a method based on any of the first through fourth examples above, wherein the amount of the ion-exchanged polycondensate of formula [I] is 2 to 50 percent based on the dry weight of the clay present in the clay-bearing aggregates.

In a sixth example embodiment, the invention is a method based on any of the first through fifth examples above, wherein the amount of the ion-exchanged polycondensate of formula [I] is 3 to 40% based on the dry weight of the clay present in the clay-bearing aggregates.

In a seventh example embodiment, the invention is a method based on any of the first through sixth examples above, wherein the amount of the ion-exchanged polycondensate of formula [I] is 4 to 30% based on the dry weight of the clay present in the clay-bearing aggregates.

In an eighth example embodiment, the invention is a method based on any of the first through seventh examples above, wherein the clay-bearing aggregates are selected from fine aggregate (e.g., sand), coarse aggregate (e.g., gravel, stone), or a mixture thereof.

In a ninth example embodiment, the invention is a method based on any of the first through eighth examples above, wherein the ion-exchanged polycondensate of formula [I] is introduced to the plurality of clay-bearing aggregates before, during, or after the ion-exchanged polycondensate is combined with a cementitious binder.

In a tenth example embodiment, the invention is a method based on any of the first through ninth examples above, wherein the plurality of clay-bearing aggregates and the ion-exchanged polycondensate of dialkylamine and epichlorohydrin are further combined with a hydratable cementitious binder and a polycarboxylate polymer water-reducing admixture.

In an eleventh example embodiment, the invention is a method based on any of the first through tenth examples above, wherein the plurality of clay-bearing aggregates and the ion-exchanged polycondensate of dialkylamine and epichlorohydrin are further combined with a hydratable cementitious binder and at least one chemical admixture selected from the group of water reducing agents (e.g., lignin sulfonate, naphthalene sulfonate formaldehyde condensate (NSFC), melamine sulfonate formaldehyde condensate (MSFC), polycarboxylate comb polymers (containing alkylene oxide groups such as “EO” and/or “PO” groups), gluconate, and the like); set retarders; set accelerators; defoamers; air entraining agents; surface active agents; and mixtures thereof.

In a twelfth example embodiment, the invention is an aggregate composition made from any of the methods described for any of the first through eleventh examples described above.

In a thirteenth example embodiment, the invention is an admixture composition comprising:

an ion-exchanged polycondensate of dialkylamine and epichlorohydrin as represented by structural formula [I],

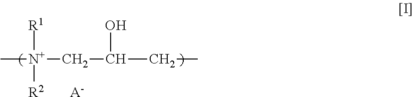

wherein R¹ and R² each independently represent C1 to C3 alkyl groups; and wherein A⁻ represents anionic groups comprising both acetate and chloride ionic groups wherein the amount of acetate is 51-99 percent based on molar concentration of the anionic groups represented by A⁻; and further wherein A⁻ comprises a chloride ionic group in the amount of 1-49 percent based on molar concentration of the anionic groups represented by A⁻; and at least one chemical admixture (such as a water-reducing admixture) for modifying a property of cement, mortar, or concrete.

In a fourteenth example embodiment, the invention is an admixture composition based on the thirteen example embodiment wherein the at least one water-reducing agent for plasticizing cement, mortar, or concrete is selected from the group of water reducing agents (e.g., lignin sulfonate, naphthalene sulfonate formaldehyde condensate (NSFC), melamine sulfonate formaldehyde condensate (MSFC), polycarboxylate comb polymers (containing alkylene oxide groups such as “EO” and/or “PO” groups), gluconate, and the like); set retarders; set accelerators; defoamers; air entraining agents; surface active agents; and mixtures thereof.

In a fifteenth example embodiment, the invention is an admixture composition based on the thirteen through fourteenth example embodiments, which admixture composition comprises a polycarboxylate comb polymer water-reducing agent for concrete.

In a sixteenth example embodiment, the invention is an additive composition for treating compositions containing clay-bearing aggregates (e.g., hydratable cementitious compositions, dry or wet aggregate piles, asphalt, etc.) comprising an ion-exchanged polycondensate of dialkylamine and epichlorohydrin as represented by structural formula [I],

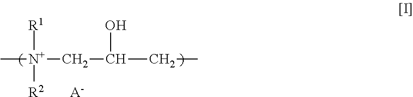

wherein R¹ and R² each independently represent C1 to C3 alkyl groups; and wherein A⁻ represents anionic groups comprising both acetate and chloride ionic groups wherein the amount of acetate is 51-99 percent based on molar concentration of the anionic groups represented by A⁻; and further wherein A⁻ comprises a chloride ionic group in the amount of 1-49 percent based on molar concentration of the anionic groups represented by A⁻; and at least one chemical admixture (such as a water-reducing admixture) for modifying a property of cement, mortar, or concrete.

Concerning gas and oil well applications, the low-chloride cationic polymer of the present invention may be introduced into the aqueous well bore cement slurry or drilling fluid or mud, which in turn stabilizes subterranean clay-bearing formations.

As mentioned in the summary, the above-described low-chloride cationic polymer can also be used in wellbore drilling applications, such as wellbore mud drilling fluid and/or wellbore cementing compositions and methods for servicing wellbores. As described in US 2007/0261849 of Valenziano et al., natural resources such as gas, oil, and water residing in subterranean formations or zones are usually recovered by drilling a wellbore down to the subterranean formation while circulating a drilling fluid (also known as a drilling mud) through the drill pipe and the drill bit and upwardly through the wellbore to the surface. The drilling fluid serves to lubricate the drill bit and carry drill cuttings back to the surface. After the wellbore is drilled to the desired depth, the drill pipe and drill bit are typically withdrawn from the wellbore while the drilling fluid is left in the wellbore while the drilling fluid is left in the wellbore to provide hydrostatic pressure on the formation penetrated by the wellbore and thereby prevent formation fluids from flowing into the wellbore. Next, the wellbore drilling operation involves running a string of pipe, e.g., casing, in the wellbore. Primary cementing is then typically performed whereby a cement slurry is pumped down through the string of pipe and into the annulus between the string of pipe and the walls of the wellbore, whereby the drilling mud is displaced, and the cement slurry sets into a hardened mass (i.e., sheath) and thereby seals the annulus.

The present inventors believe that the above-described low-chloride cationic polymer is suitable for use as a clay mitigating agent in aqueous wellbore drilling fluid (mud) compositions and/or wellbore cementing compositions. Among the advantages or purposes of doing this is to stabilize argillaceous formations like shales and/or clays in the wellbore which could otherwise be weakened and displaced by water in the aqueous wellbore mud. Because of the saturation and low permeability of a shale formation, penetration of a small volume of wellbore fluid into the formation can result in a considerable increase in pore fluid pressure near the wellbore wall, which, in turn, can reduce the effective cement support, which leads to a less stable wellbore condition.

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by percentage dry weight unless otherwise specified.

### Example 1

### Material Description:

An aqueous solution of epichlorohydrin and dimethylamine condensate (EPI-DMA, FL2250) was obtained from SNF Floerger, France. Ion chromatography measurement indicated that the chloride concentration of this 50% solution was 13.34%. The ion chromatography conditions were as follows: 10 mM potassium hydroxide as mobile phase, injection volume of 25 mL, flow rate of 1 mL/minute, column temperature at 30° C., Dionex™ ICS-2100 system, Dionex™ Ilonpac™ AS19 analytical column, and Dionex™ Ionpac™ AG19 guard column.

The chloride ions of the condensate polymer were then exchanged with acetate ions via ion exchange method. The resulting solution was then adjusted to 59% active which was described as clay controlling additive (CCA). The chloride content of this CCA solution was measured to be 3.07% by ion chromatography. The acetate % of the CCA was calculated as follows:

Acetate %=100*(1−((Cl % of CCA at 100% active)/(Cl % of EPI-DMA at 100%))

Based on these chloride concentrations, the clay controlling additive (CCA) was determined to contain 80% acetate and 20% chloride as counter ions.

### Example 2

This example illustrates the performance of the clay controlling additive (CCA) in fine aggregates. The methylene blue value (MBV) test was carried out according to ASTM C1777-14. Using external calibration, the MBV value was converted to sodium montmorillonite, described as % Mo-Meq. The sand was then treated with CCA at two different dosages, described as % solid CCA to clay (% s/clay).

Table 1 shows the results for six different sands.

TABLE 1

| | | | | MBV |
|---|---|---|---|---|
| Manufactured | CCA Dose | MBV | Clay content | Reduction |
| Sand | (% s/clay) | (mg/g) | (% Mo-Meq) | (%) |
| | none | 3.1 | 1.36 | — |
| A | 4.2 | 2.6 | 1.15 | 16.1 |
| | 8.4 | 1.8 | 0.78 | 41.9 |
| | none | 3.4 | 1.47 | — |
| B | 3.9 | 2.4 | 1.06 | 29.4 |
| | 7.8 | 1.8 | 0.79 | 47.1 |
| | none | 3.6 | 1.58 | — |
| C | 3.6 | 2.7 | 1.17 | 25.0 |
| | 7.2 | 2.3 | 1.02 | 36.1 |
| | none | 4.5 | 1.97 | — |
| D | 2.9 | 2.9 | 1.27 | 35.6 |
| | 5.8 | 2.3 | 0.99 | 48.9 |
| | none | 5.0 | 2.2 | — |
| E | 3.5 | 3.7 | 1.61 | 26.0 |
| | 7.0 | 2.6 | 1.14 | 48.0 |
| | none | 5.1 | 2.21 | — |
| F | 2.6 | 4.0 | 1.8 | 21.6 |
| | 5.1 | 3.4 | 1.47 | 33.3 |

It is clear from Table 1 that the clay controlling additive (CCA) of the invention exhibited excellent performance in reducing MBV values even at very low dosages.

### Example 3

The efficacy of the clay controlling additive (CCA) of the invention was also evaluated in mortar using sand contaminated with varying amounts of clay which was measured according the methods described in Example 1. The test was performed in accordance to JIS A 5201 and the mix design comprised of Ordinary Portland cement, slag, sand, and water in the ratio of 300/690/1764/509 by weight. A polycarboxylate-based water-reducing admixture, commercially available under the MIRA® 186 brand name from GCP Applied Technologies Inc., Cambridge, Mass., USA) was also employed in all mixes. Both mortar slump and flow were measured at 3-minute, 2-hour, and 4-hour marks and the results are summarized in Table 2.

TABLE 2

| MBV | | | | | | | | | |
|---|---|---|---|---|---|---|---|---|---|
| of | Clay | Polycarboxylate | CCA | At 3-min | | At 2-hr | | At 4-hr | |
| Sand | (% Mo- | Dose (% | Dose | Slump | Flow | Slump | Flow | Slump | Flow |
| (mg/g) | Meq) | s/cement) | (% s/clay) | (mm) | (mm) | (mm) | (mm) | (mm) | (mm) |
| 1.1 | 0.36 | 0.06 | none | 140 | 260 | 80 | 135 | 60 | 110 |
| | | 0.06 | 15 | 145 | 340 | 125 | 210 | 80 | 140 |
| 1.2 | 0.41 | 0.13 | none | 140 | 340 | 130 | 240 | 120 | 190 |
| | | 0.13 | 10 | 150 | 480 | 150 | 450 | 150 | 420 |
| 1.5 | 0.54 | 0.20 | none | 150 | 260 | 100 | 160 | 80 | 145 |
| | | 0.20 | 10 | 150 | 530 | 150 | 530 | 150 | 530 |
| 1.8 | 0.68 | 0.16 | none | 130 | 260 | 110 | 150 | 65 | 120 |
| | | 0.16 | 15 | 150 | 500 | 150 | 500 | 150 | 500 |

The results in Table 2 clearly indicate that the clay controlling additive (CCA) of the invention mitigated the detrimental effects of clay and showed increases in both slump and flow at all three time intervals for all contaminated sands.

### Example 4

The performance of the clay controlling additive (CCA) of the invention was also evaluated in concrete using a mixture of clean, natural sand and manufactured sand which contaminated with clay at 0.96% Mo-Meg. The mix design included 145 Kg/m³ of OPC cement, 55 Kg/m³ of fly ash, 66 Kg/m³ of slag, 407 Kg/m³ of natural sand, 515 Kg/m³ of manufactured sand, 312 Kg/m³ of 10 mm stone, 711 Kg/m³ of 20 mm stone, 190 Kg/m³ of water, and a water-to-cementitious ratio of 0.714. A polycarboxylate-based admixture was also used at a dosage of 0.086% solid/cement.

The mixing procedure was as follows: (1) mix manufactured sand with the CCA for one minute; (2) add natural sand, stone and mix for one minute; (3) add cement, fly ash, slag and mix for 15 seconds; (4) add 80% of water and mix for 2 minutes; (5) add polycarboxylate admixture and the rest of water and mix for three minutes. After mixing, the slump, air content, and the 7-, 28- and 56-day compressive strength of the concrete were determined.

The results are shown in Table 3.

TABLE 3

| Manufactured Sand | CCA Dosage (% s/clay) | | |
|---|---|---|---|
| (0.96% Mo-Meq) | none | 5.0 | 10.0 |
| Slump (mm) | 85 | 120 | 135 |
| Air (%) | 2.0 | 1.9 | 2.0 |
| 7-d strength (MPa) | 19.8 | 19.2 | 19.6 |
| 28-d strength (MPa) | 32.2 | 30.9 | 31.5 |
| 56-d strength (MPa) | 38.2 | 34.2 | 38.0 |

As shown in Table 3, the clay controlling additive (CCA) of the invention clearly exhibited clay mitigating effect as it provided an increase in slump workability, as compared to the control, while maintaining other fresh and hardened concrete properties.

### Example 5

This example demonstrates the performance of the clay controlling additive (CCA) of the invention in concrete using clean sand which was doped with various amounts of clay in the absence and presence of a polycarboxylate superplasticizer. The concrete mix design was formulated as follows: 385 Kg/m³ of cement, 875 kg/m³ of sand, 600 Kg/m³ of 19 mm stone, 400 Kg/m³ of 9 mm of stone, and varying amounts of water for various water-to-cement ratios.

In all concrete mixes, sodium montmorillonite (commercially available under the trade name POLARGEL® from American Colloid Company, Illinois, USA) was used as clay and was pre-hydrated to form a 5 wt % suspension in water. The weight of dry sodium montmorillonite was used as percentage by weight of sand while the amount of solid polycarboxylate superplasticizer was used as percentage by weight of cement.

The concrete mixing procedure was as follows: (1) mix sand, stone, and clay suspension for 30 seconds; (2) add water and defoaming agent and mix for 1 minute; (3) add cement and mix for 1 minute; (4) if needed, add polycarboxylate superplasticizer and mix for 3 minutes; (5) stop mixer and rest for 3 minutes; (6) re-mix for 2 minutes. After mixing, the slump was determined and the results are shown in Table 4 below.

TABLE 4

| | | | Slump (mm) at CCA | | | |
|---|---|---|---|---|---|---|
| W/C | Superplasticizer | Clay | Dose (% s/clay) of | | | |
| Ratio | (% s/cement) | (% s/sand) | 0 | 10 | 20 | 30 |
| 0.55 | none | 0.0 | 200 | — | — | — |
| | none | 0.4 | 100 | 138 | 144 | 172 |
| 0.53 | none | 0.0 | 185 | — | — | — |
| | none | 0.6 | 66 | 100 | 120 | 150 |
| 0.42 | 0.09 | 0.0 | 216 | — | — | — |
| | 0.09 | 0.3 | 35 | 88 | 163 | 184 |
| 0.41 | 0.14 | 0.0 | 228 | — | — | — |
| | 0.14 | 0.6 | 15 | 134 | — | 220 |

The results in Table 4 clearly indicate the efficacy of the clay controlling additive (CCA) of the invention to mitigate the negative impact of clay and to recover the slump workability. This performance was significantly augmented when a carboxylate superplasticizer was used.

### Example 6

In this example, the performance of the clay controlling additive (CCA) of the invention was evaluated in self-consolidating concrete (SCC) wherein the clean sand was doped with two levels of sodium montmorillonite clay. The mix design was as follows: 445 Kg/m3 of cement, 870 Kg/m3 of sand, 530 Kg/m3 of 19 mm stone, 355 Kg/m3 of 9 mm of stone, and water. The amount of water was 183 L/m3 for 0.2% clay or 192 L/m3 for 0.4% clay, yielding water-to-cement ratios of 0.41 and 0.43, respectively. The polycarboxylate superplasticizer was used at a dosage of 0.12% solid to cement by weight in all mixes. The mixing procedure was the same as described in Example 4. The concrete flow (spread) and compressive strength were measured and summarized in Table 5.

TABLE 5

| | | | | Compressive | | |
|---|---|---|---|---|---|---|
| W/C | Clay | CCA Dose | Slump | Strength (MPa) at | | |
| Ratio | (% s/sand) | (% s/clay) | (mm) | 1-day | 7-day | 28-day |
| 0.41 | none | 0 | 700 | 24.9 | 41.1 | 48.5 |
| | 0.2 | 0 | 475 | 23.7 | 40.8 | 49.2 |
| | 0.2 | 3 | 525 | 23.8 | 40.9 | 51.6 |
| | 0.2 | 8 | 613 | 25.0 | 42.1 | 51.5 |
| | 0.2 | 9.3 | 650 | 23.1 | 42.0 | 51.1 |
| 0.43 | none | 0 | 670 | 22.7 | 38.8 | 48.7 |
| | 0.4 | 0 | 215 | 22.1 | 34.7 | 46.2 |
| | 0.4 | 4 | 313 | 22.9 | 35.3 | 44.9 |
| | 0.4 | 8 | 425 | 23.1 | 36.5 | 46.2 |
| | 0.4 | 16 | 650 | 22.0 | 38.9 | 49.7 |

The data in Table 5 indicate that the clay controlling additive (CCA) of the present invention suppressed the detrimental effect of clay and increased the concrete flow workability with negligible impact on concrete strength.

The foregoing examples and embodiments were presented for illustrative purposes only and not intended to limit the scope of the invention.

It is claimed:

1. A method for controlling clay impurities in construction aggregates, comprising: combining, with a plurality of clay-bearing aggregates, an ion-exchanged polycondensate of dialkylamine and epichlorohydrin as represented by structural formula [I], 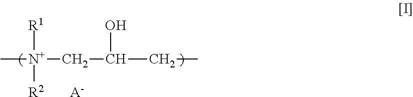
wherein R¹ and R² each independently represent C1 to C3 alkyl groups; and A⁻ represents anionic groups comprising both acetate and chloride ionic groups wherein the amount of acetate is 51-99 percent based on molar concentration of the anionic groups represented by A⁻; and
further wherein A⁻ comprises a chloride ionic group in the amount of 1-49 percent based on molar concentration of the anionic groups represented by A⁻.

2. The method of claim 1 wherein the amount of acetate is 60-95 percent based on molar concentration of the anionic groups represented by A⁻.

3. The method of any of claims 1 to 2 wherein the amount of acetate is 70-90 percent based on molar concentration of the anionic groups represented by A⁻.

4. The method of any of claims 1 to 3 wherein both R¹ and R² each independently represent methyl groups.

5. The method of any of claims 1 to 4 wherein the amount of the ion-exchanged polycondensate of formula [I] is 2 to 50 percent based on the dry weight of the clay present in the clay-bearing aggregates.

6. The method of any of claims 1 to 5 wherein the amount of the ion-exchanged polycondensate of formula [I] is 3 to 40% based on the dry weight of the clay present in the clay-bearing aggregates.

7. The method of any of claims 1 to 6 wherein the amount of the ion-exchanged polycondensate of formula [I] is 4 to 30% based on the dry weight of the clay present in the clay-bearing aggregates.

8. The method of any of claims 1 to 7 wherein the clay-bearing aggregates are selected from sand, gravel, crushed stone, or mixture thereof.

9. The method of any of claims 1 to 8 wherein the ion-exchanged polycondensate of formula [I] is introduced to the plurality of clay-bearing aggregates before, during, or after the ion-exchanged polycondensate is combined with a cementitious binder.

10. The method of any of claims 1 to 9 wherein the plurality of clay-bearing aggregates and the ion-exchanged polycondensate of dialkylamine and epichlorohydrin are further combined with a hydratable cementitious binder and a polycarboxylate polymer water-reducing admixture.

11. The method of any of claims 1 to 10 wherein the plurality of clay-bearing aggregates and the ion-exchanged polycondensate of dialkylamine and epichlorohydrin are further combined with a hydratable cementitious binder and at least one chemical admixture selected from the group of water reducing agents, set retarders, set accelerators, defoamers, air entraining agents, surface active agents, and mixtures thereof.

12. The method of any of claim 11 wherein the at least one chemical admixture is a polycarboxylate comb polymer water reducing agent.

13. Aggregate composition made from the method of any of claims 1 to 12.

14. An admixture composition comprising:
(A) an ion-exchanged polycondensate of dialkylamine and epichlorohydrin as represented by structural formula [I], 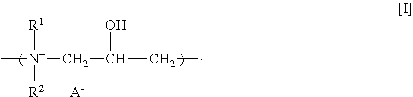
wherein R¹ and R² each independently represent C₁ to C₃ alkyl groups; and A⁻ represents anionic groups comprising both acetate and chloride ionic groups wherein the amount of acetate is 51-99 percent based on molar concentration of the anionic groups represented by A⁻; and further wherein A⁻ comprises a chloride ionic group in the amount of 1-49 percent based on molar concentration of the anionic groups represented by A⁻; and
(B) at least one water-reducing agent for plasticizing cement, mortar, or concrete.
